(19) United States
(12) Patent Application Publication
(10) Pub. No.: US 2023/0382796 A1
(43) Pub. Date: Nov. 30, 2023

(54) COMPOSITION OF AN INSULATION MATERIAL AND A SOLID INSULATION MATERIAL IN ITSELF

(71) Applicant: AEROBEL BV, Bilzen (BE)

(72) Inventor: Sam CHARTOUNI, Bilzen (BE)

(73) Assignee: AEROBEL BV, Bilzen (BE)

(21) Appl. No.: 18/250,041

(22) PCT Filed: Oct. 21, 2021
(86) PCT No.: PCT/IB2021/059699

§ 371 Date: Apr. 21, 2023

(30) Foreign Application Priority Data
Oct. 21, 2020 (BE) 2020/5736

(51) Int. Cl. C04B 20/00

(52) U.S. Cl. CPC C04B 20/002; C04B 2103/32

(57) ABSTRACT

The invention relates to an insulation material comprising expanded polystyrene (EPS) granules and a binding agent, the binding agent comprising water, cement and nanocellulose. The invention further relates to a kit comprising spatially separated components for production of an insulation material, a method for manufacturing a solid insulation material, and a solid insulation material in itself.

### TECHNICAL FIELD

The invention relates to a composition of an insulation material, to a kit comprising spatially separated components for production of an insulation material, to a method for manufacturing a solid insulation material, and to a solid insulation material.

### PRIOR ART

Expanded polystyrene (EPS) has been used for many purposes for over 50 years. It was originally intended as an insulation material, which is still its largest application, in addition to packaging. EPS is produced, among other things, in the form of granules. EPS granules are used in floor and cavity insulation. They are also very suitable for post-insulation of cavity walls.

For the production of expanded polystyrene, grains or granules of polystyrene are heated with steam. The granules will inflate and expand in this way. The expanded end product is a grain or granule consisting of only a low percentage, e.g. 2%, of polystyrene and a high percentage, e.g. 98%, of gas. As such, a white EPS is obtained. Graphite is often added during the expansion process to improve the insulation value of EPS, resulting in a grey EPS.

In order to prevent an insulation material comprising EPS granules from losing its thermal insulation value due to stacking too loosely, a binding agent is added to EPS granules. The properties of this binding agent are of great importance for a final insulation value of an insulation material comprising EPS granules.

Thus, BE1021837B1 describes a composition of an insulation material, characterised in that the composition consists of polystyrene granules and glue for sticking the polystyrene granules together.

BE1021837B1 has the problem that the use of glue as a binding agent, in contrast to cement or other common binding agents for EPS granules, leads to an insulation material that is more difficult to break down afterwards, which can cause problems during renovation or demolition work.

The present invention aim to resolve at least some of the above-mentioned problems.

### SUMMARY OF THE INVENTION

In a first aspect, the invention relates to a composition of an insulation material comprising expanded polystyrene (EPS) granules and a binding agent, according to claim 1. Preferred forms of the composition are set forth in claims 2 to 15.

In a second aspect, the invention relates to a kit comprising spatially separated components for production of an insulation material, according to claim 16. A preferred form of the kit is set forth in claim 17.

In a third aspect, the invention relates to a method for manufacturing a solid insulation material, according to claim 18. Preferred forms of the method are set out in claims 19 to 23.

In a fourth aspect, the invention relates to a solid insulation material comprising expanded polystyrene (EPS) granules and a binding agent, according to claim 24. Preferred forms of the solid insulation material are set forth in claims 25 and 26.

### DETAILED DESCRIPTION OF THE INVENTION

Quoting numerical intervals by endpoints comprises all integers, fractions and/or real numbers between the endpoints, these endpoints included.

The expression ‘percentage by weight’, here and throughout the text, refers to the relative weight of a respective component based on the total weight of a composition of components.

The term ‘lambda value’ in this text refers to the thermal-conduction coefficient of a material and expresses how much heat is conducted per unit of time through a surface of 1 m 2 with a thickness of 1 m at a temperature difference of 1° C. (1 K). This is related to the thermal resistance coefficient R of a material layer with thickness d if λ=d/R. These units are defined according to ISO 10456. A low lambda value means a high thermal insulation value or a high thermal insulating effect.

In a first aspect, the invention relates to a composition of an insulation material comprising expanded polystyrene (EPS) granules and a binding agent, according to claim 1.

The composition of an insulation material according to the first aspect of the invention has the advantage that a solid insulation material finally formed from the composition has a sufficiently high thermal insulation value and at the same time is composed of readily available components based on natural materials that are easy to recycle. A further advantage is that due to a bonding of the EPS granules obtained by the binding agent, a final solid insulation material also exhibits a sufficient compressive strength.

Preferably, the EPS granules are fully pre-expanded. EPS granules without additives, such as graphite, are white in colour. EPS granules offer the advantages of a high thermal insulation value, full recyclability and up to five times recyclable, a moisture-resistant and moisture-insensitive material, high efficiency due to optimal filling, high dimensional stability, high pressure resistance, vapour permeable and light weight. Preferred embodiments of the EPS granules are described below.

According to embodiments of the first aspect of the invention, the cement comprises one or more materials selected from the group of Portland cements, pozzolana cements, gypsum cements, gypsum compositions, aluminous cements, magnesium oxide cements, silica cements, slag cements, Type I cement, Type IA cement, Type II cement, Type IIA cement, Type III cement, Type IIIA cement, Type IV cement and Type V cement. The composition of the cement can be chosen based on the weather conditions, based on the cost price, and/or based on the desired compressive strength of a final solid insulation material. In a preferred embodiment, the cement is a cement that meets at least strength class 32.5 N according to the European cement standard EN 197-1. According to preferred embodiments, one or more cement types with strength class (according to EN 197-1) 42.5 N or 52.5 N are used as cement. More preferably, the cement comprises from 90 to 100 percentage by weight of a Portland composite cement, relative to the total weight of the cement, which Portland composite cement is well known as a grey cement obtained by co-milling Portland cement clinker with pulverised coal fly ash, and with limestone or blast furnace slag.

The term ‘nanocellulose’ in this text refers to nanostructured cellulose. In this text, ‘nanocellulose’ refers in particular to cellulose nanocrystals or cellulose nanofibres, also called nanofibrillated cellulose, whose fibre widths are typically 5-20 nanometres with a wide possible range in length, typically several micrometres. Preferably, nanofibrillated cellulose is selected as nanocellulose. Nanocellulose can be extracted from wood and, for example, from wood pulp. For this reason, nanocellulose is a material with good availability and a sustainable character. By planting new trees, the wood consumption for the production of nanocellulose can be compensated. In one embodiment, the nanocellulose may be added as a nanocellulose gel wherein the gel contains a specific percentage of nanocellulose. In one embodiment, the nanocellulose gel may contain a solid content of nanocellulose between 0.5 and 20%, between 1 and 10%, between 1.5 and 5%, such as 3%.

Nanocellulose is very suitable as a reinforcing filler, thus improving the mechanical properties of a final solid insulation material formed by the composition. In addition, nanocellulose acts as a stabiliser of the insulation material composition before forming the composition into a final solid insulation material. Nanocellulose is also known as a material with low thermal conductivity.

The EPS granules function as an insulating material in the composition because of their good insulation value. In the composition, the binding agent serves to stick the EPS granules together. Cement and nanocellulose perform a dual function of filling agent and binding agent.

Preferred forms of the composition are set forth in claims 2 to 15.

In a more preferred embodiment of the embodiment of the composition as described in claim 2, the composition comprises from 5 to 15 percentage by weight of EPS granules, expressed relative to the total weight of the composition.

In a more preferred embodiment of the embodiment of the composition as described in claim 3, the composition comprises from 50 to 60 percentage by weight of water.

In a more preferred embodiment of the embodiment of the composition as described in claim 4, the composition comprises from 30 to 45 percentage by weight of cement.

In a more preferred embodiment of the embodiment of the composition as described in claim 5, the composition comprises from 0.03 to 1 percentage by weight of nanocellulose.

In a more preferred embodiment of the embodiment of the composition as described in claim 6, the composition comprises:
from 5 to 15 percentage by weight of EPS granules;
from 50 to 60 percentage by weight of water;
from 30 to 45 percentage by weight of cement; and
from 0.03 to 5 percentage by weight of nanocellulose,
   wherein the weight percentages are expressed relative to the total weight of the composition.

The relative amounts of EPS granules, water, cement and nanocellulose, according to claims 2-6 and the more preferred embodiments described above, provide a composition for an insulation material which can be used for production of a solid material with optimum thermal insulation value and at the same time a sufficient compressive strength.

The preferred embodiments of the composition as described in claims 7 and 8 offer the advantage that said densities and particle sizes of EPS granules are most suitable for obtaining a desired thermal insulation value of a final solid insulation material. EPS granules with a larger particle size had a negative effect on the insulating effect of the final solid insulation material. More preferably, the EPS granules have a density of 12 to 20 g/L. More preferably, the EPS granules have a particle size of 2 to 6 mm.

An additive according to the preferred embodiment of the composition, as described in claim 9, increases the thermal insulation value of a final solid insulation material obtained from the composition. In addition, for polystyrene particles that still need to be foamed, the said additive reduces the amount of blowing agent released in the actual pre-foaming stage. The particle size of said additive is preferably 12 μm, more preferably 8 μm and even more preferably 5 μm.

The preferred embodiment of the composition as described in claim 10 offers the advantage that graphite provides an optimal increase in the thermal insulation value of EPS granules. EPS granules comprising graphite are also known by a person skilled in the art as ‘grey’ EPS granules. Grey EPS granules can be produced by adding graphite when forming non-expanded polystyrene granules (which later have to be expanded or foamed into EPS granules). Grey EPS granules have better insulating properties. These are passed on to the final solid insulation material.

The preferred embodiment of the composition as described in claim 11 provides the effect that said relative amounts of one or more pigments are optimally suited to provide the composition with a desired colour. Non-limiting examples of pigments are carbon black, metal oxides, metal powders and dye pigments.

The preferred embodiment of the composition as described in claim 12 provides the effect that when producing a final solid insulation material from the composition, a foam is produced by mixing the foaming agent with water, which foam ensures that the EPS granules can be brought into suspension and do not float (because of their low density). Any suitable foaming agent as known in the art can be selected.

In a more preferred embodiment of the embodiment of the composition as described in claim 12, the composition comprises 0.005 to 0.5 percentage by weight of foaming agent.

The preferred embodiment of the composition as described in claim 13 offers the advantage that the viscosity increasing substance by its viscosity-increasing action prevents bleeding and segregation of the composition upon production of a final solid insulation material from the composition. Any suitable viscosity increasing substance as known in the art can be selected. Preferably, the viscosity increasing substance is a high molecular weight polymer.

The preferred embodiment of the composition as described in claim 14 offers the advantage that the superplasticiser has excellent liquefying and water-reducing properties for cement-comprising systems, and ensures that a desired homogeneous and liquid consistency of a cement-comprising system can be obtained in very short mixing times. A self-levelling composition is obtained by adding the superplasticiser. Any suitable superplasticiser as known in the art can be selected. Preferably, the superplasticiser is a superplasticiser based on polycarboxylate ethers.

According to embodiments of the composition, the composition comprises flame retardants to improve the flammability of the final material, additives to improve chemical resistance, and the like. The addition of materials with a high specific gravity, for example sand or quartz sand, to increase the sound insulation of the material are also known.

In one embodiment, the binding agent also comprises a surfactant. In another or further embodiment, the binding agent comprises aerogel. Aerogel is a transparent, porous material with an extremely low density. It is typically 95 to 99.98% air, making it one of the lightest solids. The structure of the most studied aerogels is determined by silicon, but there are also aerogels based on metals or carbon compounds. Aerogel is often made by drying a conventional gel above the critical temperature of the solvent and a critical pressure. This gel consists of silica in colloidal form, filled with solvents.

The addition of aerogel provides a better insulating factor. In a preferred form, 0.001 to 10 percentage by weight of aerogel is added. In case nanocellulose gel is used, the aerogel can be added to the nanocellulose gel, preferably at a percentage by weight between 1 and 10%.

In a second aspect, the invention relates to a kit comprising spatially separated components for production of an insulation material, according to claim 16.

The kit comprising spatially separated components for production of an insulation material according to the second aspect of the invention has the advantage that just before use EPS granules on the one hand and binding agent on the other hand can be combined with each other, which offers advantages in terms of storability and efficient use of materials.

A preferred form of the kit is set forth in claim 17. Accordingly, all technical embodiments and positive features of a kit according to the second aspect of the invention are combined with those of a composition according to the first aspect of the invention.

In a third aspect, the invention relates to a method for manufacturing a solid insulation material, according to claim 18.

The method is very suitable for manufacturing a solid insulation material with a sufficiently high thermal insulating effect because the binding agent ensures the sticking together of the EPS granules with a high thermal insulating effect. At the same time, a solid insulation material obtained by means of the method has a sufficient compressive strength.

In one embodiment of the method, the method also comprises a preliminary step of producing EPS granules. Non-expanded polystyrene granules are fully expanded, for example using a 4 m×1 m×1.2 m block press. For this, superheated steam is used, at a pressure of 800 to 1000 bar, e.g. 900 bar, and a temperature of 200 to 220° C., e.g. 210° C., which acts on the non-expanded polystyrene granules for a short peak of 4 to 8 s, e.g. 6 s. By using only one steam step, as discussed here, an optimum density and consequently an optimum thermal insulation value of the EPS granules can be obtained. This is in contrast to the prior art, in which usually two steam steps are used for expanding polystyrene granules.

Preferred forms of the method are set out in claims 19 to 23.

In the preferred embodiment of the method according to the third aspect of the invention according to claim 19, binding agent and EPS granules according to the first aspect of the invention are used. For the technical effects and advantages and/or preferred embodiments of EPS granules or binding agent in the method according to the third aspect of the invention, reference is hereby made to the above-described embodiments of the composition according to the first aspect of the invention wherein EPS granules and binding agent and embodiments thereof have been described and which are also applicable to the method according to the third aspect of the invention.

According to an embodiment of the method, the binding agent is initially at least partially powdery, the method comprising the step of dispersing the powdery binding agent in water.

The preferred embodiment of the method according to the third aspect of the invention as described in claim 20 offers the advantage that foam formed by mixing water with a foaming agent causes the EPS granules (because of their low density) to float, which promotes an even distribution of the EPS granules in the binding agent.

The preferred embodiment of the method according to the third aspect of the invention as described in claim 21 offers the advantage that a final solid insulation material has a smooth surface, which is mainly important when applying the insulation material to a substrate. When using a superplasticiser, preferably a superplasticiser based on polycarboxylate ethers, such a levelling step can be skipped.

The preferred embodiment of the method according to the third aspect of the invention as described in claim 22 offers the advantage that the insulation material is transported in a liquid and thus easily transportable state to a place to eventually harden into a solid insulation material. This offers the further advantage that places that are difficult to reach, such as a cavity wall, can easily be provided with a solid insulation material.

An eccentric screw pump thus installed according to the preferred embodiment of the method described in claim 23 offers the advantage that said liquid insulation material can be produced at an exceptionally high flow rate.

In a fourth aspect, the invention relates to a solid insulation material comprising expanded polystyrene (EPS) granules and a binding agent, according to claim 24.

Such a solid insulation material has a sufficiently high thermal insulation value because the binding agent ensures the sticking together of the EPS granules with thermal insulating effect. At the same time, the solid insulation material has a sufficient compressive strength and preferably a compressive strength of at least 80 kPa. Preferred forms of the solid insulation material are set forth in claims 25 and 26.

The preferred embodiment of the solid insulation material as described in claim 25 offers the advantage that said lambda value testifies to a very high thermal insulation value of the solid insulation material. For comparison, traditional cement-based insulation materials with EPS granules (also called ‘EPS mortars’) show a significantly higher lambda value of 0.050 W/mK on average. More preferably, the solid insulation material according to the invention has a lambda value lower than 0.040 W/mK, even more preferably lower than 0.038 W/mK, and still more preferably lower than 0.036 W/mK, such as determined according to ISO 10456. A further advantage of a solid insulation material according to the fourth aspect of the invention is that, because of its higher thermal insulating effect, the solid material can be made thinner (and can therefore be sprayed thinner during production) in order to obtain the same thermal insulation.

With the preferred embodiment of the kit as described in claim 26, all the technical embodiments and positive features of a solid insulation material according to the fourth aspect of the invention are combined with those of a composition according to the first aspect of the invention, kit according to the second aspect of the invention or method according to the third aspect of the invention.

In what follows, the invention is described by way of non-limiting examples illustrating the invention, and which are not intended to and should not be interpreted as limiting the scope of the invention.

### EXAMPLES

For advantages and technical effects of elements described below in the Examples, reference is made to the advantages and technical effects of corresponding elements described above in the detailed description.

### Example 1

Example 1 relates to a composition of an insulation material according to embodiments of the first aspect of the invention, as shown in Table 1.

TABLE 1
Composition of an insulation material comprising expanded
polystyrene (EPS) granules and binding agent comprising
water, cement and nanocellulose as components, according
to embodiments of the invention, wherein amounts of the
various components are expressed in weight percentages
relative to the total weight of the composition.

| | Quantity (percentage by |
|---|---|
| Component | weight) |
| EPS granules with a particle | 5-15 |
| size of 2 to 6 mm and a | |
| density of 12 to 20 g/L | |
| water | 50-60 |
| cement | 30-45 |
| nanocellulose | 0.03-5 |

### Example 2

Example 2 relates to a composition of an insulation material according to Example 1, wherein a pigment is included in an amount of 0.01 to 5% by weight relative to the total weight of the composition.

### Examples 3-4

Examples 3 and 4 concern compositions according to Examples 1 or 2, respectively, wherein a foaming agent is included in an amount of 0.005 to 0.5% by weight relative to the total weight of the composition.

### Examples 5-8

Examples 5-8 are respectively compositions according to one of Examples 1-4, in which the EPS granules comprise graphite.

### Examples 9-16

Examples 9-16 concern kits according to embodiments of the second aspect of the invention. The kits comprise spatially separated components for production of an insulation material comprising a first component A and a second component B, wherein the first component (A) comprises EPS granules and the second component (B) a binding agent. The kits according to Examples 9-16 comprise as first component (A) EPS granules, and as second component a binding agent (B) with binding agent components, which EPS granules and separate components correspond to EPS granules and separate components as described for the compositions of an insulation material according to Examples 1-8, respectively.

### Example 17

Example 17 relates to a method of manufacturing a solid insulation material wherein EPS granules are evenly distributed in a binding agent, according to embodiments of the third aspect of the invention.

The binding agent comprises water, cement and nanocellulose. More preferably, EPS granules and binding agent are used in relative amounts corresponding to one of the compositions according to Examples 1-8. In order to smoothly handle raw materials used during the process, it is moreover particularly convenient to use a kit according to one of Examples 9-16.

In this example, use is made of a reservoir comprising EPS granules, a reservoir comprising binding agent and a foaming chamber. In the foaming chamber, water is mixed with a foaming agent to form a foam. The EPS granules and the binding agent are then added via pipes from their reservoir simultaneously or sequentially into the foaming chamber, wherein during mixing of the content in the foaming chamber the EPS granules are bonded together with the binding agent in an evenly distributed state to form the liquid insulation material. For mixing the contents of the foaming chamber and for transporting liquid insulation material, an eccentric screw pump is used, which is installed in the mixing chamber.

The liquid insulation material thus obtained is transferred from the foaming chamber to a substrate and/or into a cavity wall.

After transport of the liquid insulation material on substrates and/or in cavity walls, the liquid insulation material hardens into a solid insulation material with a good thermal insulation value. In the case of insulation material on substrates, it may be desirable to level the liquid insulation material before curing. However, by adding a superplasticiser, preferably a superplasticiser based on polycarboxylate ethers, such a levelling step is made superfluous.

### Examples 18-25

Examples 18-25 relate to solid insulation materials according to embodiments of the fourth aspect of the invention, and obtained by the process of Example 17, in which use is made of the compositions of Examples 1-8, respectively. Lambda values of 0.035 to W/mK were determined for the solid insulation materials according to ISO 10456. Variations in lambda values can be explained by the presence or absence of graphite in the different insulation materials. The measured lambda values each testify to a very good thermal insulation value. Traditional cement-based insulation materials with EPS granules show a considerably higher lambda value of 0.050 W/mK on average, as determined in accordance with ISO 10456. The solid insulation materials according to Examples 10-13 also have a sufficient compressive strength and preferably a compressive strength of at least 80 kPa.

1. A composition of an insulation material comprising expanded polystyrene (EPS) granules and a binding agent, characterised in that the binding agent comprises water, cement and nanocellulose.

2. The composition according to claim 1, comprising from 2 to 20 percentage by weight of EPS granules, expressed relative to the total weight of the composition.

3. The composition according to claim 1, comprising 40 to 70 percentage by weight of water, expressed relative to the total weight of the composition.

4. The composition according to claim 1, comprising 25 to 50 percentage by weight of cement, expressed relative to the total weight of the composition.

5. The composition according to claim 1, comprising 0.02 to 2 percentage by weight of nanocellulose, expressed relative to the total weight of the composition.

6. The composition according to claim 5, comprising:
from 2 to 20 percentage by weight of EPS granules;
from 40 to 70 percentage by weight of water;
from 25 to 50 percentage by weight of cement; and
from 0.02 to 5 percentage by weight of nanocellulose,
wherein the weight percentages are expressed relative to the total weight of the composition.

7. The composition according to claim 1, wherein the EPS granules have a density of 10 to 22 g/L.

8. The composition according to claim 1, wherein the EPS granules have a particle size of 1 to 8 mm.

9. The composition according to claim 1, wherein the EPS granules comprise an additive selected from the group of activated carbon, graphene, graphite and ground carbon.

10. The composition according to claim 9, wherein graphite is selected as additive.

11. The composition according to claim 1, wherein the binding agent comprises one or more pigments in a total amount of 0.01 to 5 percentage by weight relative to the total weight of the composition.

12. The composition according to claim 1, wherein the binding agent comprises one or more foaming agents in an amount of 0.002 to 1 percentage by weight relative to the total weight of the composition.

13. The composition according to claim 1, wherein the binding agent comprises a viscosity increasing substance.

14. The composition according to claim 1, wherein the binding agent comprises a superplasticiser.

15. The composition according to claim 1, wherein the binding agent comprises a surfactant and/or an aerogel.

16. A kit comprising spatially separated components for production of an insulation material, comprising a first component A and a second component B, wherein the first component (A) comprises EPS granules and the second component (B) comprises a binding agent, characterised in that the binding agent comprises water, cement and nanocellulose.

17. A kit according to claim 16, wherein for components (A) and (B), respectively, EPS granules and binding agent, characterised in that the binding agent comprises water, cement and nanocellulose.

18. A method for manufacturing a solid insulation material wherein EPS granules are evenly distributed in a binding agent, resulting in a liquid insulation material, after which the liquid insulation material cures into a solid insulation material, characterised in that the binding agent comprises water, cement and nanocellulose.

19. (canceled)

20. The method according to claim 18, wherein, to form the liquid insulation material, water is mixed with a foaming agent in a foaming chamber, after which EPS granules and a binding agent are added simultaneously or sequentially into the foaming chamber, wherein during mixing of the content in the foaming chamber the EPS granules are bonded together with the binding agent in an evenly distributed state to form the liquid insulation material.

21. The method according to claim 18, wherein the method comprises levelling the liquid insulation material before curing the liquid insulation material

22. (canceled)

23. (canceled)

24. (canceled)

25. (canceled)

26. (canceled)
